(19) United States
(12) Patent Application Publication
(10) Pub. No.: US 2011/0179954 A1
(43) Pub. Date: Jul. 28, 2011

(54) MULTI-PURPOSE BASKET

(76) Inventors: Anna M. Stewart, Naples, NY (US); Stephen Kraigh Stewart, Naples, NY (US)

(21) Appl. No.: 12/693,618

(22) Filed: Jan. 26, 2010

(51) Int. Cl. A47J 47/00; B65D 8/04

(52) U.S. Cl. 99/427; 220/676

(57) ABSTRACT

A multi-purpose basket, particularly well suited for boiling, steaming, blanching, rinsing, straining, chilling, drying and storing items. The basket includes a flexible basket made from silicone, along with silicon top that attaches to the pod by having a plurality of protrusions from the top extend through holes in the pod. The pod includes multiple holes to allow fluid and/or gasses to enter and exit the pod but, are sized such that the contents generally remain within the pod interior. The basket includes a handle that has a cord attached to the top on one end and to a handle grip on the other end. Further, the handle grip includes a slotted cavity that allows the handle to be attached to other items, such as the side of a pot.

### CROSS-REFERENCE TO RELATED APPLICATIONS

This application is a non-provisional application being filed under 35 USC 111 and claiming priority to the application for a design patent filed in the United States on Mar. 19, 2009 and assigned serial No. 29/334,054 and bearing the title of FOOD POD.

### BACKGROUND

As the old saying goes, “if you can't stand the heat, get out of the kitchen”. Although GOOGLE can generally help one find the answers too many questions, finding the exact origin of this statement has proven to be a difficult task. Most attribute the saying to President Harry S. Truman who was recorded as using this saying, at least in a similar form, prior to his presidency, and then in this exact form during his presidency. But regardless of the origins, the saying is a practical statement of a real life scenario that has been applied to a multitude of situations to make the clear analogy that if you can't handle the situation you are in, then move on to another one.

Another option, or variation to this saying would be “if you can't stand the heat, then figure out a better way to do the task”. That motive may just be the driving factor in most innovation—the quest for building a better mouse trap. It is also the driving force behind the inventors of the products developed and marketed by FUSION BRANDS, INC.

Cooks and moms have been using them for years, and occasionally, even a child will be seen using one as a space helmet. The them being referred to is a colander, a kitchen utensil that can be used for rinsing, straining, steaming, boiling and deep frying a variety of items, as well as panning for gold, washing marbles or as mentioned prior, playing spaceman. However, over the years very little, if any, improvements have been made to the colander. Other similar products in the same area have been referred to steam baskets, boiler baskets and perforated baskets.

Although the colander has proven to be quite useful in a variety of situations, the bowl shaped perforated device used for rinsing and cleaning vegetables was most certainly not designed with all of its current uses in mind. As such, the colander remains quite useful for rinsing and straining, as well as other tasks but, what is needed in the art is a device that is constructed and designed specifically with other tasks in mind.

### BRIEF SUMMARY

The present disclosure meets the above-defined needs, as well as a variety of other needs in the art by providing a multi-purpose basket or pod, that due to its various features and design structures, can be used for a variety of purposes but, is primarily being presented as a basket used in boiling, blanching, steaming, chilling, warming and/or drying, items, as well as other uses. In one embodiment, the basket is constructed of FDA/EU food-safe silicone and BPA-free nylon but, in other embodiments a variety of materials and combinations of materials can be used. In one use of the basket, the device can be used for containing, removing and draining foods like eggs, veggies, shellfish and more in one easy-to-use vessel. For example, the basket can be used to boil items, such as eggs or broccoli. In operation, the items are placed into the basket and the basket is placed in water to cook. When the items or ready, the basket can be lifted from the water and the water drains out of the basket. The food items can then be removed from the basket and served. Advantageously, as a cooking utensil, the various embodiments advantageously help to save time and water when preparing a meal, facilitate the even cooking of the items as they are immersed and removed at substantially the same time, keeps the food items together for quick and easy removal, operates as a strainer and drains water back into the pot for further cooking, can be constructed of various sized to hold a desired amount or volume of items, includes a built in grip to allow for convenient removal from water and aids in boil over control, is fabricated from non-stick silicone to protect delicate foods and pot surfaces, can be flexed to fin in a variety of pot sizes or for storage, and can be washed in a dishwasher.

One of the embodiments is described as a multi-purpose basket that includes a pod, a top and a handle. The pod includes a wall or a shell that defines a pod opening, an interior area of the pod and a plurality of holes on the surface of the wall or shell. The holes extend from the outside of the pod to the inside of the pod to create fluidity between the interior area of the pod and the exterior. In general, the holes vary in size but, some or all of the holes may actually be the same size. The holes are generally sized to allow fluid and/or gasses to freely flow in and out of the pod but to retain the contents within the interior of the pod.

The top that corresponds to the pod opening and can either be attached over the opening, is integral to the pod and can be moved over the opening, or is fixed over the opening. The top may include a beanie-like or cup-like cover and a plurality of fingered flanges protruding from the edge of the cup-like cover. In the attachable version, at least a subset of the holes defined by the pod wall are proximate to the pod opening and correspond with the fingered flanges of the cup-like cover when oriented in a particular manner. In an exemplary embodiment, the pod and the top are constructed of silicon and the pod is substantially more flexible than the top. In some embodiments, pod is rigid enough to maintain its shape in the absence of pressure being applied to the walls of the pod. In other embodiments an empty pod may simply collapse when set down on a surface.

The handle is configured to lift the multi-purpose basket and includes a cord with end of the cord corresponding or being associated with the top and the other end either being connected to a handle grip or being unattached. Typically, the end of the cord is attached or integral to the top. The handle grip defines a cavity with an opening to the edge of the grip (i.e., a slotted cavity) that can be slid onto the lip of a pot or pan, or some other similar structure to hold the basket in position.

In one embodiment, the multi-purpose basket is contoured by a plurality of concave and convex surfaces extending vertically on the sides of the pod. The vertical convex surfaces extend at least partially under the pod defining supports to hold the pod in an upright position. Further, the vertical concave surfaces extend at least partially under the pod defining fluidity channels so that fluid (including gasses and/or liquids) can flow up through the bottom or down through the bottom.

### BRIEF DESCRIPTION OF THE SEVERAL VIEWS OF THE DRAWING

FIG. 1 is a perspective view of an exemplary embodiment of the basket that includes a handled top.

FIG. 2 is a top elevated view of the embodiment illustrated in FIG. 1.

FIG. 3 is a side view in a first orientation of the embodiment illustrated in FIG. 1.

FIG. 4 is a side view in a second orientation of the embodiment illustrated in FIG. 1.

FIG. 5 is a bottom view of the pod 102.

FIG. 6 is an enlarged view of the top 104 for the configuration of the basket 100 illustrated in FIG. 1.

FIG. 7 is a top view of an alternative embodiment of a top and handle for the pod illustrated in the embodiment of FIG. 1.

FIG. 8 is a perspective view of the pod illustrated in FIG. 1 with a cinching handle.

### DETAILED DESCRIPTION OF EMBODIMENTS OF THE INVENTION

The present disclosure presents the design of a multi-purpose basket or pod that due to its various features and design structures, can be used for a variety of purposes but, is primarily being presented as a basket used in chilling, warming and/or boiling items. The various embodiments are simply referred herein to as a basket. In general, the various embodiments of the basket include a sack, pouch or pod that includes multiple holes or perforations around the sides and the bottom to facilitate the saturation of the basket when emerged in a liquid, as well as a quick draining of the liquid when the basket is retracted from the liquid. Such features enable the various embodiments to be well suited for uses such as, but not limited to, boiling, straining, rinsing, cooling, and drying various items. The figures illustrate the various embodiments, aspects and features of the basket and, the various views are provided wherein similar or common elements among the views are shown with common labels where appropriate.

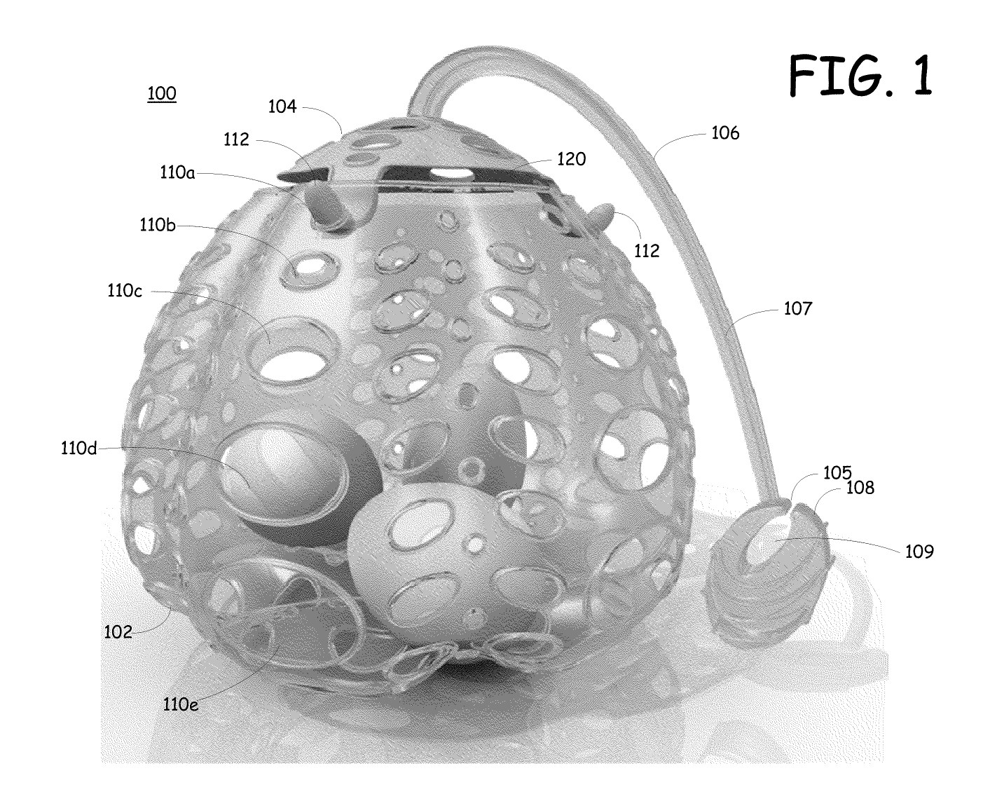

FIG. 1 is a perspective view of an exemplary embodiment of the basket that includes a handled top. In this embodiment of the basket 100, a sack, pouch or pod 102 (referred to herein after as the pod) is shown with a top 104 and handle 106. The pod is a container that includes an interior and an exterior defined by the pod shell. In some embodiments the pod shell can be constructed of heat resistant silicone, but in other embodiments, it will be appreciated that a variety of materials may be used including, but not limited to aluminum, metal, plastic, cloth, wood, glass, etc. In the illustrated embodiment, the pod is shown as being sufficiently rigid to retain its shape when sitting at rest. However, it will be appreciated that in other embodiments, the pod can be completely collapsible or completely rigid. In the silicon based embodiment, the pod retains its shape but, can be distorted by the application of pressure. The shell defines multiple holes or perforations 110 that are shown as being distributed over the entire surface of the pod including the sides and the bottom. However, it will be appreciated that in some embodiments, the holes may only be defined in certain regions of the pod 102, such as the bottom, the bottom half, limited to certain sides, limited to the upper portions, etc. The holes 110 can be of a variety of sizes and, in the illustrated embodiment, multiple sized holes are shown as being defined by the pod shell.

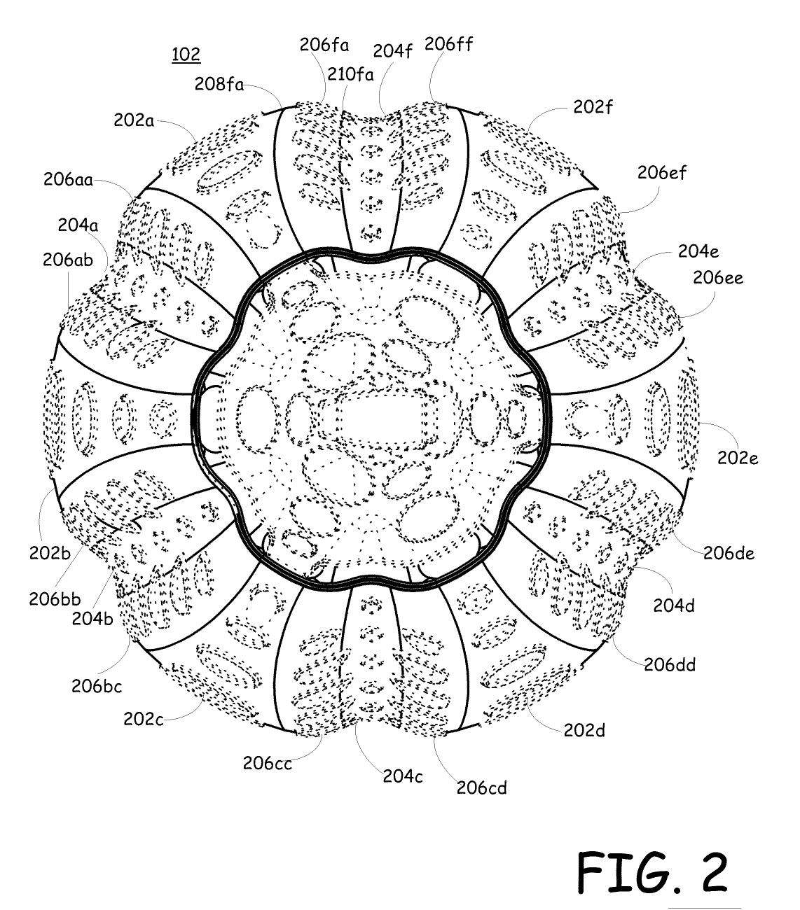

FIG. 2 is a top elevated view of the embodiment illustrated in FIG. 1. From the top view, the pod 102 is illustrated as being constructed using a ridged or contoured structure. The contoured structure of the pod 102 includes six (6) convex portions 202a-f and six (6) concaved portions 204a-f with transitional areas 206aa-fa between them. More specifically, convex portion 202a is positioned between convex portions 204a and 204f. Convex portion 202a is joined with transitional area 206fa at point 208fa and concave portion 202f is joined with transitional area 206fa at point 210fa. Advantageously, the contoured structure of the pod 102 provides a level of rigidity to help the pod retain its shape. It should be appreciated that the structure described for the transition between convex portion 202a and convex portion 204f can be identically duplicated for each of the other transitions or, can be modified to create a non-uniform look. In addition, the joining of the convex, transition, and concave portions is described as occurring at specific lines or points. In some embodiments, these points may be well defined, such as by using ridges but in other embodiments, the points may simply be gradual transitions as opposed to absolute, visible transitions.

Returning to FIG. 1, the multiple holes 110 were previously described as being of various sizes in the illustrated embodiment. Although the illustrated structure is only one example of many configurations, the illustrated pod 102 is shown as defining holes of increasing sizes on the convex portions with the smaller holes 110a being defined near the top and the larger holes 110e being defined near the bottom. The concave portions of the pod 102 are shown as having holes of a uniform size ranging from near the top to near the bottom of the side. In the embodiment illustrated in FIG. 1, the transitional portions also are shown as defining holes. The holes in the transitional portions also increase in size from near the top of the pod 102 towards the bottom but, with a less dramatic change than the holes in the convex portion. In fact, in the illustrated embodiments, the first three holes near the top increase in size, while the remaining holes are substantially the same size. The holes in the transition portions are shown as being elliptically shaped and angled upwards, or slightly rotated on an axis angled up from the convex portion towards the concave portion.

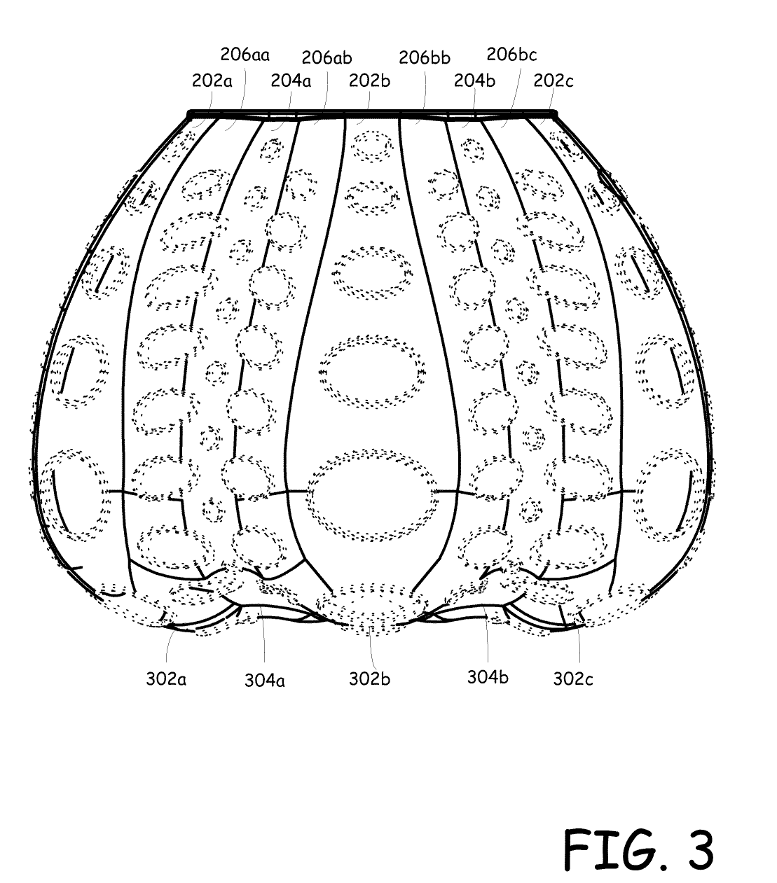

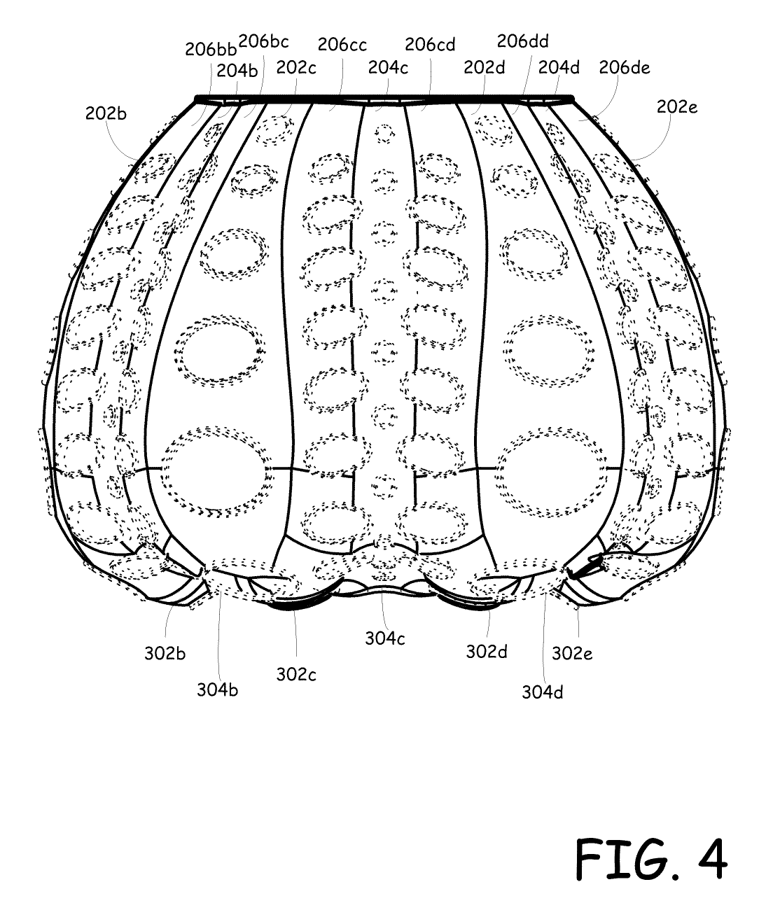

FIG. 3 is a side view in a first orientation of the embodiment illustrated in FIG. 1. FIG. 4 is a side view in a second orientation of the embodiment illustrated in FIG. 1. The side views show that the convex portions of the pod form a series of feet or supports on the bottom of the pod that operate to support the pod in an upright position. The convex portions of the pod 102, curve around underneath the pod 102 and form the feet or supports on the bottom of the pod 102. As illustrated in FIG. 3, convex portion 202b is shown as corresponding with support 302b, convex portion 202a corresponds with support 302a and convex support 202c corresponds with support 302c. In addition, the bottom of the pod 102 also includes raised areas between each of the supports. The raised areas generally correspond with the concave portions of the pod 102. As such, concave portion 204a corresponds with raised area 304a and concave portion 204b corresponds with raised area 304b. Looking at FIG. 4, this feature of this embodiment is further illustrated by supports 302b, 302c, 302d and 302e corresponding with convex portions 202b, 202c, 202d and 202e and raised areas 304b, 304c and 304d corresponding with concave areas 204b, 204c and 204d.

Thus, in the illustrated embodiment of the pod 102, the bottom forms a series of undulations in which the lower dipping portions serve as supports. Advantageously, this configuration allows for fluidity flow up under the pod 102, which facilitates a variety of uses for the bucket, including drying, boiling and/or steaming items within the basket.

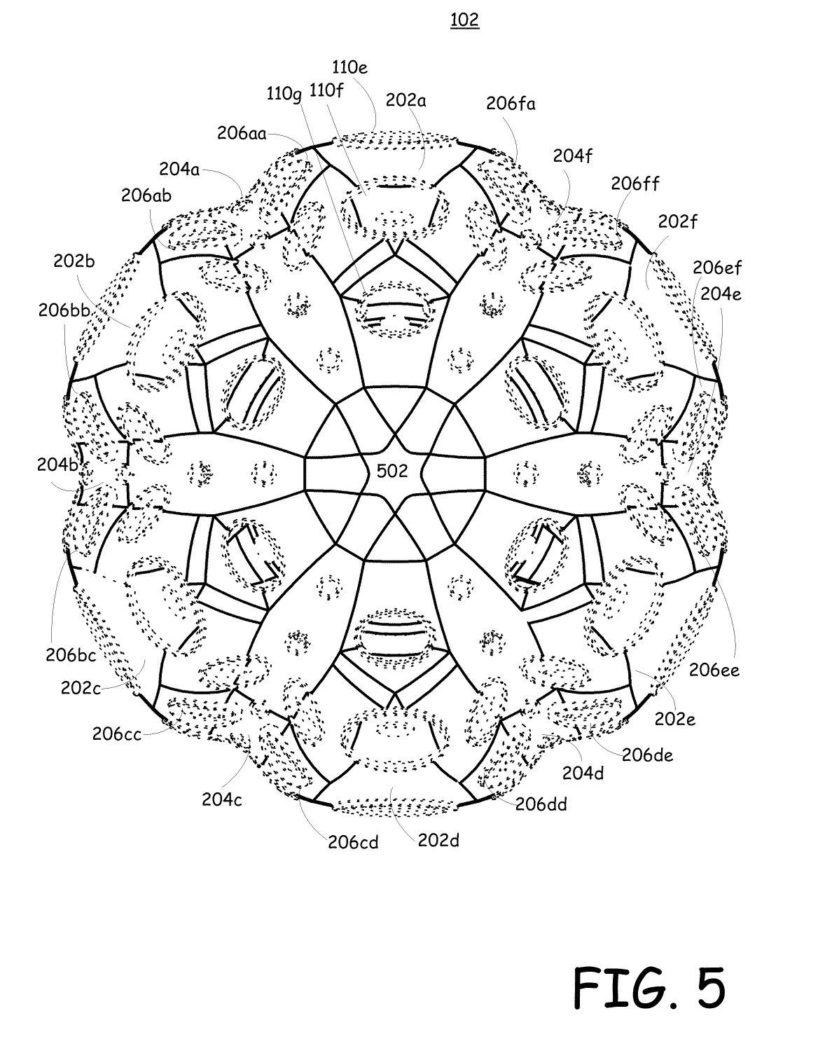

FIG. 5 is a bottom view of the pod 102. Each of the convex, concave and transitional portions are again labeled in this view. From the bottom view, I this embodiment the holes defined in the convex portions are shown to decrease in size as the convex portion wraps underneath the pod 102. As such, hole 110e is larger than hole 110f which is larger than hole 110g. In addition, although the contours of the bottom are not completely ascertainable from FIG. 5, it should be appreciated that the center of the bottom 502 is raised above the plane of the supports as the various portions all merge in a single point at the bottom center 502. As previously mentioned, an advantage of this design is that there are fluid flow channels or paths underneath the pod 102. Another advantage is on the interior of the pod 102, the bottom center is a raised area that can force items within the pod 102 towards the side of the pod.

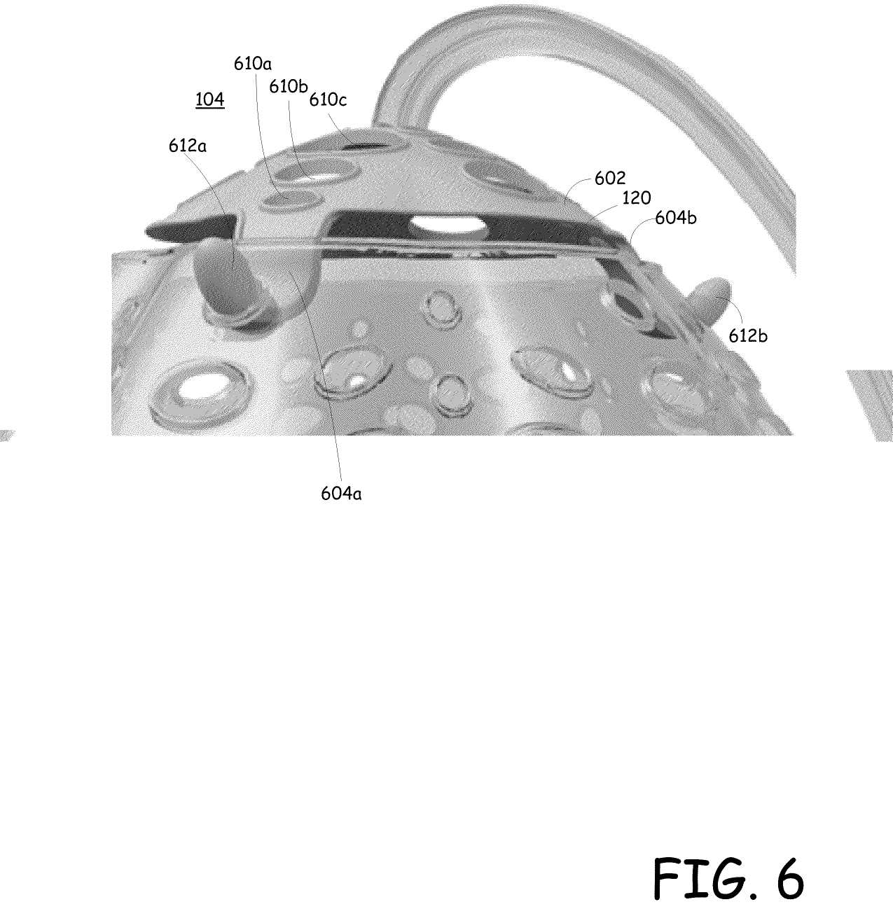

Returning to FIG. 1, in this embodiment the basket 100 is shown as including top 104. The top is shown as including a beanie like cover that sits above the pod 102 and is coupled to the pod 102 by a series of flanges, each with fingers that protrude through particular holes of the pod 112. FIG. 6 is an enlarged view of the top 104 for the configuration of the basket 100 illustrated in FIG. 1. The top 104 includes a beanie-like cover 602 with a series of flanges 604 that extend from the edges. In the illustrated embodiment, the cover 104 includes three (3) such flanges (although only two are visible) but, it should be appreciated that more or fewer flanges can be utilized in other embodiments. The illustrated flanges 604 extend in a downwardly and outwardly direction from the beanie-like cover 602 and then turn outward as they taper into a finger-like protrusion 612. The material of the top 104, or at least the flanges 604, is chosen such that the flanges have a spring-like quality. Thus, if pressure is applied to force the flange in a direction towards the underside of the beanie-like cover 602, potential energy is absorbed such that when the pressure is removed, then the flanges will spring back to an at rest position, which as describes extends downwardly and outwardly from the beanie-like cover 602.

In the illustrated embodiment, the spacing of the flanges 604 is such that they align with holes in the pod 102. More specifically, in the illustrated embodiment, the three (3) flanges are spaced around the perimeter of the beanie-like top 602 at approximately 120 degree angles to each other from the center of the top 104. This configuration results in the fingers being able to be aligned with every other hole near the top of the convex portions 202.

In application, a user can compress the flanges 604 inwardly and insert them into an upper opening 120 in the top of the pod 102. The top 104 can then be rotated to align the fingers with the holes in the pod 102. When the pressure to the flanges is released, the fingers protrude through the holes of the pod 102. Advantageously, this configuration results in holding the top in place and, is secure enough to allow a full pod 102 to be lifted only by the a force applied to the top 104 (i.e. by lifting handle element 106). It should be appreciated that the exact holes used for coupling the top 104 to the pod 102 do not have to be the upper holes of the convex portions, but rather could exist in any portion of the pod, as well as multiple portions.

In some embodiments, the top can be rigid or substantially rigid, even including the flanges, such that the application of pressure to the flanges does not result in significant compression of the flanges. In this embodiment, the pod can be flexible enough to allow the upper opening of the pod to be stretched over the fingered flanges of the top. In yet in other embodiments, a combination of both of these techniques may be utilized.

The top is further illustrated as including or defining holes in the beanie-like cover 602. In the illustrated embodiment, the holes are aligned on 60 degree angles from the center of the beanie-like cover 602 with every other set of holes being in alignment with a flange 604. More specifically, looking at the holes corresponding with flange 604, three holes 610a, 610b and 610c are shown as extending from the flange or near the periphery of the beanie-like cover 602 towards the center of the beanie-like cover 602. The holes further away from the center are small while the holes closer to the center are larger for the holes that align with a flange 604. Thus, the size of 610a is smaller than 610b which is smaller than 610c.

Other top embodiments, may include snaps, the illustrated rope, screw on, hooks, clamps, clips, ties (such as the FOODLOOP, a product manufactured and marketed by the assignees of the embodiments described in this specification), buttoned, zipper-locked, etc. In addition, in some embodiments, the top may be integral with the pod and/or may be permanently attached to the pod. In such embodiments, the top may be connected only at one point of the pod in a hinge like or flexible connection such that the top can be lifted to give access to the upper opening of the pod. In yet another embodiment, the spacing between the top and the pod may be such that a permanently attached or affixed top and/or the pod can be flexed to allow items to be placed into the interior of the pod between the top and upper opening of the pod. In addition, the top may alternately be configured such that the flanges are on the outside of the pod and the fingers protrude through the holes of the pod from the outside, towards the inside of the pod. In yet other embodiments, a combination of interior and exterior flanges may be included in the structure of the top.

In yet other embodiments, the pod may be closed on the top, or the top may be permanently attached or integral to the pod, and the side of the pod may include an opening that is used for inserting and removing items from the pod interior. In such embodiments, the side opening may be constructed with mating fingered flanges and holes, similar to the afore-described top and pod, or can use any of a variety of other techniques for closing and opening the side, including but not limited to snaps, the illustrated rope, hooks, clamps, clips, ties (such as the FOODLOOP, a product manufactured and marketed by the assignees of the embodiments described in this specification), buttoned, zipper-locked, etc.

In yet other embodiments, the pod may be closed on the top, or the top may be permanently attached or integral to the pod, and the bottom of the pod may include a removable bottom to provide access to the interior of the pod. The structure of the bottom may be similar to that of the top described in FIG. 6, as well as any of a variety of other configures, including but not limited to snaps, ties, screw on, hooks, clamps, clips, ties (such as the FOODLOOP, a product manufactured and marketed by the assignees of the embodiments described in this specification), buttoned, zipper-locked, etc.

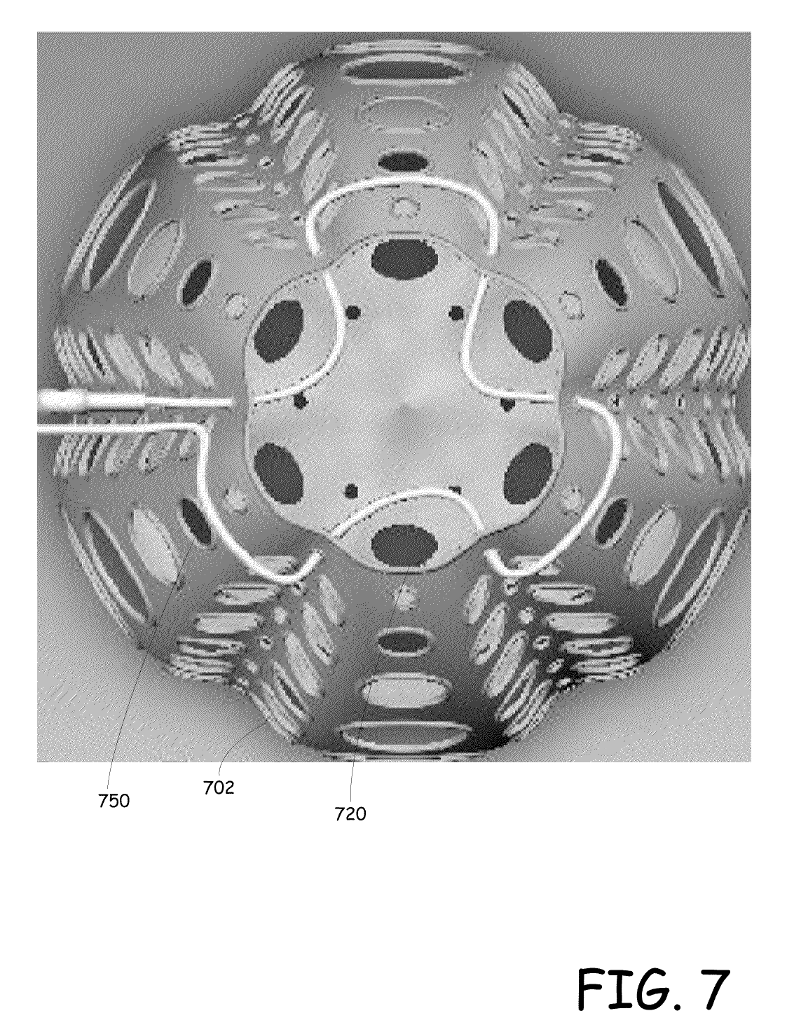

FIG. 7 is a top view of an alternative embodiment of a top and handle for the pod illustrated in the embodiment of FIG. 1. In this embodiment, rather than having a top, the upper opening 720 of the pod 702, or any opening for that matter, can be close, either completely or partially by cinching or drawing the opening together with a string, rope, thread or cord 750. The cord 750 can be manufactured from a variety of materials including, but not limited to, twine, silicon, plastic, metal, etc. In the illustrated embodiment, the cord 750 is shown as being weaved through upper holes in the pod 702. In this configuration, the cord 750 can remain loose and as such, simply be used as a handle to place and move the pod 702 or, it can be tightened down to completely or partially close the opening 720.

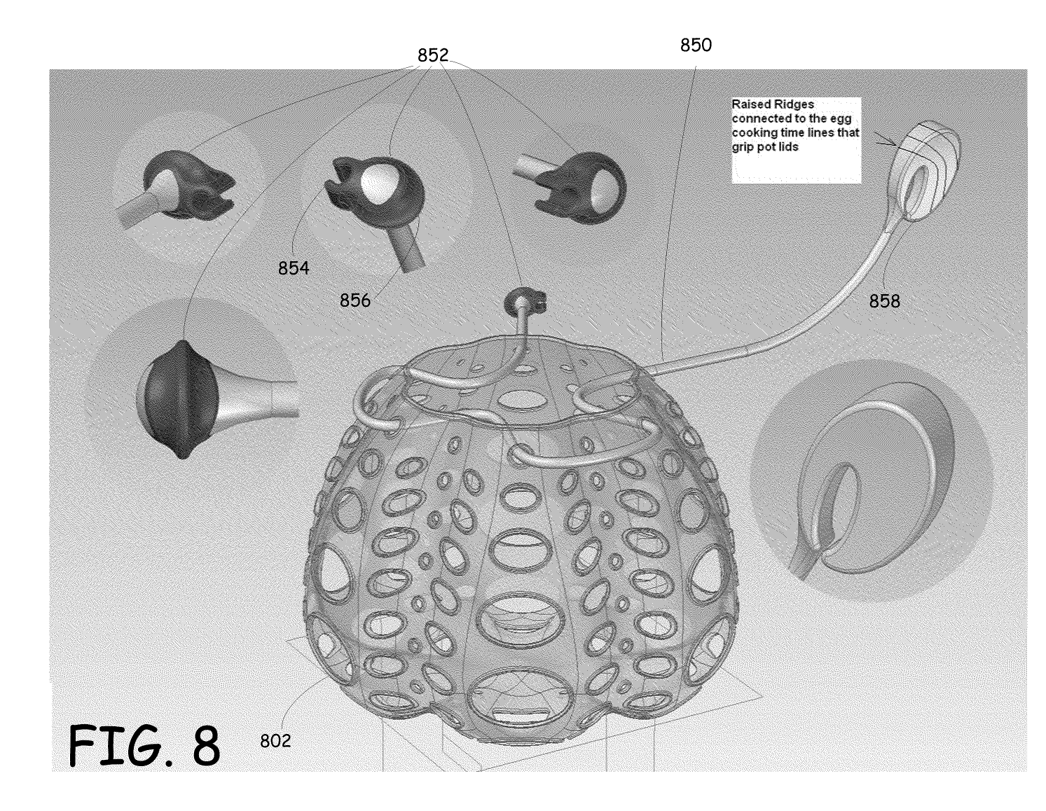

FIG. 8 is a perspective view of the pod illustrated in FIG. 1 with a cinching handle. In this embodiment, the pod 802, similar to FIG. 7 can be fully or partially closed by using a cord 850. Further, in the illustrated embodiment, several views of a cord clip 852 are shown. The cord clip 852 includes a snap on portion 854 that snugly fits around the cord so that when the cord 850 is tightened, the clip 852 can be fastened to the cord 850 to hold the top in the fully or partially closed position. The clip 852 also includes a grip element 856 to facilitate the extraction of the clip 852 from the cord 850. In operation, the pod can be closed by holding the pod 802 in one hand and the handle end 858 of the cord 850 in the other hand. Pressure can then be applied by pulling the handle end 858 of the cord while holding the pod 802 stationary. The clip This results in tightening up the cord 850 as the clip 852 is held securely against the wall of the pod 802, which in turn causes the walls of the pod 802 to collapse towards each other. Once the pod 802 is close or partially closed, the cord 850 can be secured in position by pressing it against the snap 854.

It will be appreciated that in another embodiment, a top may be attached to the pod by threading a cord through holes in the pod and holes in the top, thus in essence sewing the top to the pod. In such an embodiment, the top can be loosened to allow items to be placed within or removed from the pod. In some embodiments, the cord can include a removable end such that the cord can be threaded and unthreaded from the pod and/or top.

Returning to FIG. 1, the illustrated embodiment is shown as including a handle 106 with a handle cord 107 and a handle grip 108. The cord 107 is attached on one end to the top 104 and on the other end to the handle grip 108. It should be appreciated that the cord 107 may be alternatively attached to the pod 102 or may include a flanged lock, such as a “T” shaped end or other mechanism that allows it to be inserted into a hole in the top 104 or the pod 102 rather than being fixedly attached. The cord 107 is flexible allowing the handle grip 108 to be moved into a variety of orientations.

The handle grip 108 is illustrated as being generally oval-shaped with a handle grip hole or cavity 109 defined near one end or edge of the oval and an opening or slit 105 from the hole through the oval handle grip 108. The slit 105 in conjunction with the handle grip hole 109 and the handle grip 108 enable the handle to be attached to other items, such as the side of a pot for boiling, steaming, frying and/or blanching, a wire or grill grate for smoking, a shelf or surface in a refrigerator for cooling, a shelf for surface in a freezer for freezing, or a variety of other thin surfaces for drying, draining and/or straining.

The handle grip may also take on a variety of other structures. For instance, it may be a clamp, hook, weighted element, ring, suction cup, extend cord for tying, etc.

The present disclosure has presented various embodiments of a device and has been described in reference to various uses. It will be appreciated that many additional embodiments can exist and, the uses of the embodiments are not limited in any manner. A few additional features, aspects and functions of various embodiments are presented herein, some of which may be incorporated into various embodiments but, are not necessarily required.

For instance, some embodiments may include a mesh, screen or netting, such as a bag, on the inside to prevent small items from falling out of one of the holes. The netting can be permanently attached or may be a removable item that is inserted when desired. For example, the netting may have a rigid ring around the top to allow the bag to be placed within the pod but the ring would be too large to fit through the upper opening of the pod and so, the netting would simply hang within the pod interior. Alternatively, the netting may have hooks, flanges, buttons, fingers, or the like around the perimeter of the netting to attach to the upper holes in the pod.

Other embodiments may include an interior pod and an exterior pod that can be rotated relative to each other. In this embodiment, the size of the holes or openings can be regulated by rotating the interior and exterior pods relative to each other. For instance, if the products include identically positioned holes, in one alignment, the holes will be full opened and in another alignment they can be partially for fully closed.

Some embodiments may include multiple plugs that can be inserted into a hole in the pod and held in placed by either a snapping like action, grommet style securing, or other techniques. This feature would allow the user to selectively seal undesired holes, such as holes that may be too large for an intended use.

Another feature that can be incorporated into various embodiments is a petition or a wall that is inserted within the interior of the pod to allow multiple items to be placed in the pod without them being mixed together. The petition may be constructed of a wall with connectors, such as flanges, fingers, “T”'s, buttons, etc. on the ends. The wall can be at least partially collapsible so that it can be inserted into the pod and then held in place by extending the connectors through aligned holes in the pod. The wall can be constructed of a variety of materials such as silicone, plastic, netting, etc.

Similarly, rather than walls, various embodiments may include layers for floors that can inserted horizontally within the pod interior. For instance, if it is desired to maintain a higher level of fluidity around the items within the pod, one or more horizontal petitions can be inserted into the pod with items below and above the petition. The petition may also include holes, or may be constructed of a mesh-like material to facilitate fluidity. Advantageously, this structure also can be used to prevent items from banging or bumping into each other while they cook.

The illustrated embodiments showed that the pod was shaped such that supports were defined in the bottom of the pod. However, in some embodiments, the bottom of the pod may be substantially flat or rounded. In other embodiments, legs or supports can be molded into the pod or attached to the pod to provide support.

The baskets can be fabricated in a variety of sizes and colors. For instance, a package of several baskets may be sold with each basket having a different color. This configuration may be useful, for instance in boiling eggs in which it is desired to have different consistencies of the egg. As such, the user would know to remove the basket of one color after a first amount of time, then remove a next basket after a next amount of time.

The main embodiment illustrates that the holes in the convex portion of the pod increase in size from the top to the bottom. It should be appreciated that in some embodiments, the pod can be used either right-side up or upside down. For instance, the pod may include a top on each end and the user can select which end to receive the top with the handle. Advantageously, this configuration would allow the user to have large holes on the bottom if desired, or on the top instead.

The illustrated embodiments have shown the pod as being contoured with convex surfaces and concave surfaces running vertically up and down the side of the pod. In some embodiments, the entire pod may be smooth, such as a teardrop shape, round, cylindrical, rectangular, or any of a variety of other shapes. For instance, the use of a smooth sided shape would be most applicable in an embodiment that includes an interior and exterior pod that can be rotated relative to each other to adjust the hole sizes. In addition, the pod may be contoured in a horizontal fashion in addition to or in lieu of being vertically contoured. For instance, the pod may include a series of alternating concave and convex surfaces progressing from the top of the pod towards the bottom and extending horizontally around the circumference of the pod.

Although the embodiments have been described as being fabricated of silicone material, it should be appreciated that various other materials may also be used in various embodiments. A few non-limiting examples include cloth, mesh, plastic of various thicknesses, aluminum, stainless steel, wood, rubber, metal, etc. Although some embodiments are desired to have a pod constructed of flexible material, is should be appreciated that this is not a required element or feature of all embodiments.

Some embodiments may utilize smaller baskets that can be placed within larger baskets. Such a configuration allows a user to remove selected items from the large basket or, to remove all items simultaneously.

Uses for the various embodiments are quite varied. Some uses such as cooking, boiling, steaming, blanching, chilling, etc. have been described. More specifically, a few non-limiting uses include, boiling eggs or vegetables, steaming vegetables, rinsing items, storing potatoes, cooling soft drinks, soaking clothes, dying clothes, drying items such as socks, marinating food, smoking food, etc.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb, and as such, mean “include but is not necessarily limited to”.

The present invention has been described using detailed descriptions of embodiments thereof that are provided by way of example and are not intended to limit the scope of the invention. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art.

It will be appreciated by persons skilled in the art that the present invention is not limited by what has been particularly shown and described herein above. Rather the scope of the invention is defined by the claims that follow.

What is claimed is:

1. A multi-purpose basket comprising:
a pod, a wall that defines a pod opening, an interior area and a plurality of holes, wherein the holes create fluidity between the interior area of the pod and the exterior, wherein at least two of the defined holes are of different sizes;
a top that corresponds to the pod opening; and
a handle that is configured to lift the multi-purpose basket.

2. The multi-purpose basket of claim 1, wherein the top can be coupled to the pod.

3. The multi-purpose basket of claim 2, wherein:
the top comprises a cup-like cover and a plurality of fingered flanges protruding from the edge of the cup-like cover; and
wherein at least a subset of the holes defined by the pod wall are proximate to the pod opening and correspond with the fingered flanges of the cup-like cover when oriented in a particular manner.

4. The multi-purpose basket of claim 3, wherein the pod is constructed of flexible silicon.

5. The multi-purpose basket of claim 4, wherein the top is constructed of silicon and is less flexible than the pod.

6. The multi-purpose basket of claim 5, wherein the handle includes a cord and one end of the cord corresponds to the top.

7. The multi-purpose basket of claim 6, wherein the cord is attachable to the top.

8. The multi-purpose basket of claim 6, wherein the cord is integral to the top.

9. The multi-purpose basket of claim 8, wherein the handle includes a handle grip on the end of the cord distal to the top.

10. The multi-purpose basket of claim 9, wherein the handle grip includes cavity for coupling the handle to another item.

11. The multi-purpose basket of claim 10, wherein the pod is contoured by a plurality of concave and convex surfaces extending vertically on the sides of the pod.

12. The multi-purpose basket of claim 11, wherein the vertical convex surfaces extend at least under a portion of the pod defining supports to hold the pod in an upright position.

13. The multi-purpose basket of claim 12, wherein the vertical concave surfaces extend at least under a portion of the pod defining fluidity channels.

14. An apparatus comprising:
a pod, a wall that defines a pod opening, an interior area and a plurality of holes, wherein the holes create fluidity between the interior area of the pod and the exterior, wherein the wall further defines vertical oriented contours of alternating convex and concave surfaces and at least two of the defined holes are of different sizes;
a top that corresponds to the pod opening; and
a handle that is configured to lift the multi-purpose basket.

15. The apparatus of claim 14, wherein the top is integral to the pod but can be opened to allow items to be placed within the pod and removed from the pod.

16. The apparatus of claim 14, wherein:
the top comprises a cup-like cover and a plurality of fingered flanges protruding from the edge of the cup-like cover; and
wherein at least a subset of the holes defined by the pod wall are proximate to the pod opening and correspond with the fingered flanges of the cup-like cover when oriented in a particular manner.

17. The apparatus of claim 16, wherein the holes in the pod are substantially vertically aligned and the holes in the convex surfaces increase in size from the top of the pod towards the bottom of the pod.

18. The apparatus of claim 17, wherein the pod is fabricated from a flexible silicon material and the top is fabricated from silicon and is more rigid than the pod.

19. An apparatus comprising:
a pod, a wall that defines a pod opening, an interior area and a plurality of holes, wherein the holes create fluidity between the interior area of the pod and the exterior, wherein the wall further defines vertical oriented contours of alternating convex and concave surfaces;
a top that corresponds to the pod opening and can be coupled to the pod so as to at least partially close the pod opening; and
a handle that includes a cord with a first end affixed to the top and a second end affixed to a handle grip, the handle grip defining a cavity that can be used to connect the handle grip to another item.

20. The apparatus of claim 19, wherein the vertical convex and concave surfaces extend at least under a portion of the pod wherein the convex surfaces define supports to hold the pod in an upright position and the concave surfaces define fluidity channels for flow under the pod.
